(19) United States
(12) Patent Application Publication
(10) Pub. No.: US 2020/0100310 A1
(43) Pub. Date: Mar. 26, 2020

(54) ESTABLISHING CONNECTIONS TO CORE NETWORKS OF DIFFERENT TYPES

(71) Applicant: GOOGLE LLC, Mountain View, CA (US)

(72) Inventor: Frank Wu, Taoyuan City (TW)

(21) Appl. No.: 16/579,644

(22) Filed: Sep. 23, 2019

Related U.S. Application Data
(60) Provisional application No. 62/735,346, filed on Sep. 24, 2018.

(51) Int. Cl. H04W 76/16; H04W 48/20

(52) U.S. Cl. CPC H04W 76/16; H04W 88/06; H04W 48/20

(57) ABSTRACT

In a user device (112) that supports an air interface for connecting to core networks of different types, processing hardware selects (804) a cell in which a base station (262, 264) is connected to at least one of a core network (CN) of a first CN type or a core network of a second CN type (216,218). The processing hardware chooses a CN type from one of the first CN type or the second CN type and performs a radio resource control (RRC) connection establishment procedure (806,808, 810, 814) with the base station in accordance with the chosen CN type.

### CROSS-REFERENCE TO RELATED APPLICATION

The present application is a non-provisional application claiming priority to U.S. Provisional Patent Application No. 62/735,346, filed Sep. 24, 2018, the disclosure of which is incorporated herein by reference in its entirety for all purposes.

### FIELD OF THE DISCLOSURE

This disclosure relates to wireless communications and, more particularly, to establishing a connection between a user device and core networks of different types.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

When expanding wireless communications networks, operators sometimes configure base stations to connect to core networks (CNs) of different types. These base stations and compatible user devices (commonly referred to using the acronym UE, which stands for “user equipment”) accordingly can support air interfaces for establishing connections to different types of CNs. For example, an Evolved Universal Mobile Telecommunications System Terrestrial Radio Access (EUTRA) base station that operates in a Long Term Evolution (LTE) network will connect to an evolved packet core (EPC) or a more advanced fifth-generation core (5GC). Content and formatting of messages between such UEs and base stations in some cases depend on the type of the CN to which these messages pertain.

The 3rd Generation Partnership Project (3GPP) recently proposed to modify the protocol specification 3GPP TS 36.331 for EUTRA radio resource control (RRC) procedures and messages with specification R2-1813139 to support a EUTRA base station connected to a 5GC. Although the specification supports scenarios where a UE connects to the same CN upon selecting a cell, the problem of a UE connecting to a CN of a different CN type remains unresolved.

### SUMMARY

A user device of this disclosure is configured to support an air interface for connecting to a CN of one CN type (e.g., EPC) and a CN of another CN type (e.g., 5GC), via two different cells connected to respective different CNs. As a starting point, the UE chooses a certain CN type. For example, a module responsible for controlling the mobility management (MM) sublayer chooses EPC or 5GC. The UE then performs a radio resource control (RRC) connection establishment procedure in accordance with the chosen CN type and does not rely on the CN type to which the UE currently is connected (when a connection already exists). More particularly, the UE can use the chosen CN type to determine the content and formatting of outbound and inbound messages during the RRC connection establishment procedure.

One example embodiment of these techniques is a method in a user device that supports an air interface for connecting to core networks of different types. The method can be executed by processing hardware and includes selecting a cell in which a base station is connected to a CN of a first CN type or a CN of a second CN type, choosing a CN type from one of the first CN type or the second CN type, and performing an RRC connection establishment procedure with the base station in accordance with the chosen CN type.

Another example embodiment of these techniques is a non-transitory medium storing instructions. When executed by processing hardware of a user device, the instructions cause the user device to select a cell in which a base station is connected to one of a CN of a first CN type or a core network of a second CN type, choose one of the first CN type or the second CN type, and perform an RRC connection establishment procedure with the base station in accordance with the chosen CN type, via an air interface for connecting to core networks of at least the first CN type and the chosen CN type.

### BRIEF DESCRIPTION OF THE DRAWINGS

FIG. 1 is a block diagram of an example wireless communication network in which a user device of this disclosure is located in a EUTRA cell with a base station connected to an EPC or a 5GC;

FIG. 2 is a block diagram of an example wireless communication network in which a user device of this disclosure moves between an EUTRA cell with a base station connected to an EPC and another EUTRA cell with a base station connected to a 5GC;

FIG. 3 is a flow diagram of an example method in the user device of this disclosure for connecting to an EPC or 5GC following a power-up, when the user device has not yet attached to an EPC or 5GC;

FIG. 4 is a flow diagram of an example method in the user device of this disclosure for attaching to an EPC via one cell and subsequently registering with a 5GC via another cell;

FIG. 5 is a flow diagram of an example method in the user device of this disclosure for registering with a 5GC via one cell and subsequently attaching to an EPC via another cell;

FIG. 6 is a flow diagram of an example method in the user device of this disclosure for carrying out an access check procedure upon selecting a cell connected to a CN of a different CN type than the previous cell of the user device;

FIG. 7 is a messaging diagram of an example scenario in which a user device registers with a 5GC via a first cell, selects another cell connected to an EPC, and applies a EUTRA packet data convergence protocol (PDPC) configuration;

FIG. 8 is a messaging diagram of an example scenario in which a user device attaches to EPC via a first cell, selects another cell connected to a 5GC, and applies an NR PDCP configuration; and

FIG. 9 is a flow diagram of an example method for performing an RRC connection establishment procedure when a user device selects a cell connected to a CN of a different type.

### DETAILED DESCRIPTION OF THE DRAWINGS

Generally speaking, the techniques of this disclosure allow a UE that supports an air interface for connecting to core networks (CNs) of different CN types to establish connections that involve changes in the CN type. The CNs of different CN types can belong to the same Public Land Mobile Network (PLMN) or different PLMNs. The CNs of different CN types can belong to the same operator or different operators. As discussed in more detail below, the UE can select or reselect a cell in which the base station is connected to a CN of a first CN type or a CN of a second CN type. In this disclosure, “select” as applied to a cell can refer to selecting a cell in the first instance or reselecting a cell according to cell reselection criteria. The UE can choose one of these CN types based on various settings, preferences, signals from upper-layer modules, system information broadcast on the selected cell, etc. The UE then can perform an RRC connection establishment procedure that involves transmitting outbound messages and receiving inbound messages. During this procedure, the UE can make decisions regarding the content and format of these messages in accordance with the chosen CN type. The UE can make these decisions regardless of the CN type of the core network to which the UE currently is connected, when such a connection already exists.

These techniques are discussed below with example reference to EPC and 5GC networks. Although 5GC corresponds to a more advanced technology than EPC, the techniques of this disclosure in general are applicable to any pairs (or, potentially, larger numbers) of core networks accessible via the air interface between the UE and the base station.

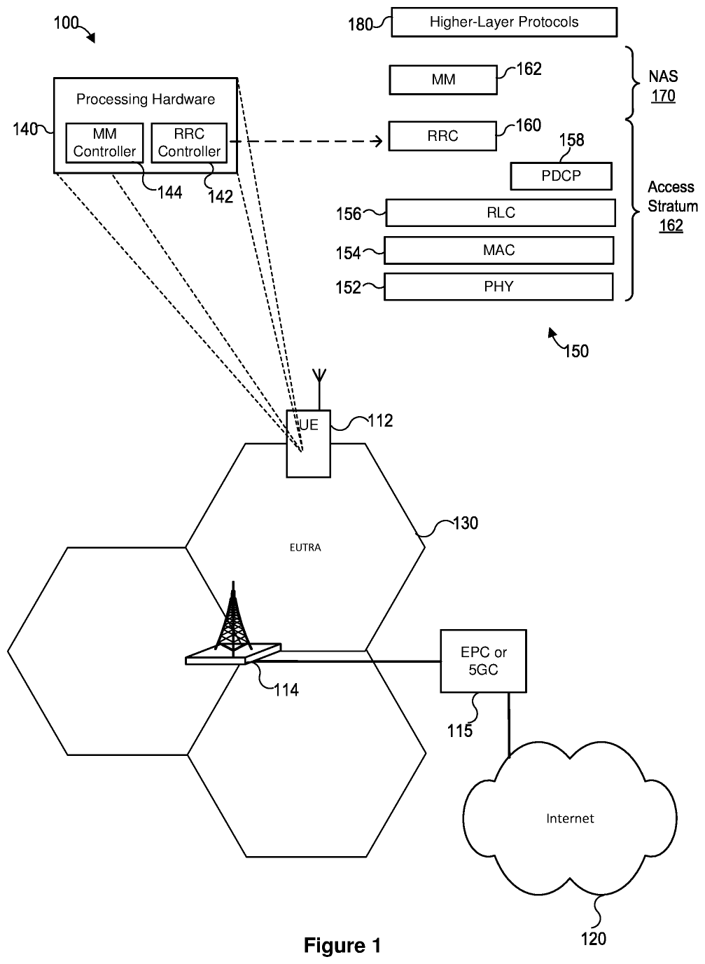

Referring first to FIG. 1, an example wireless communication network 100 includes a UE 112 and a EUTRA base station 114 connected to a core network 115 of one of two CN types: EPC or 5GC. The base station 114 operates as evolved Node B (eNB) or a next-generation eNB (ng-eNB). The core network 115 in turn is connected to the Internet 120. The base station 114 covers a cell 130 in which the UE 112 currently is located. The UE 112 is configured to exchange messages with the base station 114 using the EUTRA air interface, which supports connections to EPC as well as 5GC. As discussed below, the UE 112 can be any suitable device capable of wireless communications.

The UE 112 is equipped with processing hardware 140 that can include one or more general-purpose processors (e.g., CPUs) and a non-transitory computer-readable memory storing instructions that the one or more general-purpose processors execute. Additionally or alternatively, the processing hardware 140 can include special-purpose processing units such as a wireless communication chipset for example. The processing hardware 140 includes an RRC controller 142 configured to perform an RRC establishment procedure in accordance with the chosen CN type as well as execute other RRC functions. The processing hardware 140 also can include an MM controller 144 configured to execute various mobility management functions. The MM controller 144 performs procedures and implements messaging corresponding to an upper layer of the wireless communication protocol stack 150. Each of the RRC controller 142 and the MM controller 144 can be implemented using any suitable combination of hardware, software, and firmware. In one example implementation, the RRC controller 142 is a set of instructions that define a component of the operating system of the UE 112, and one or more CPUs execute these instructions to perform the RRC establishment procedure and other RRC functions. In another implementation, the RRC controller 142 is implemented using firmware as a part of the wireless communication chipset.

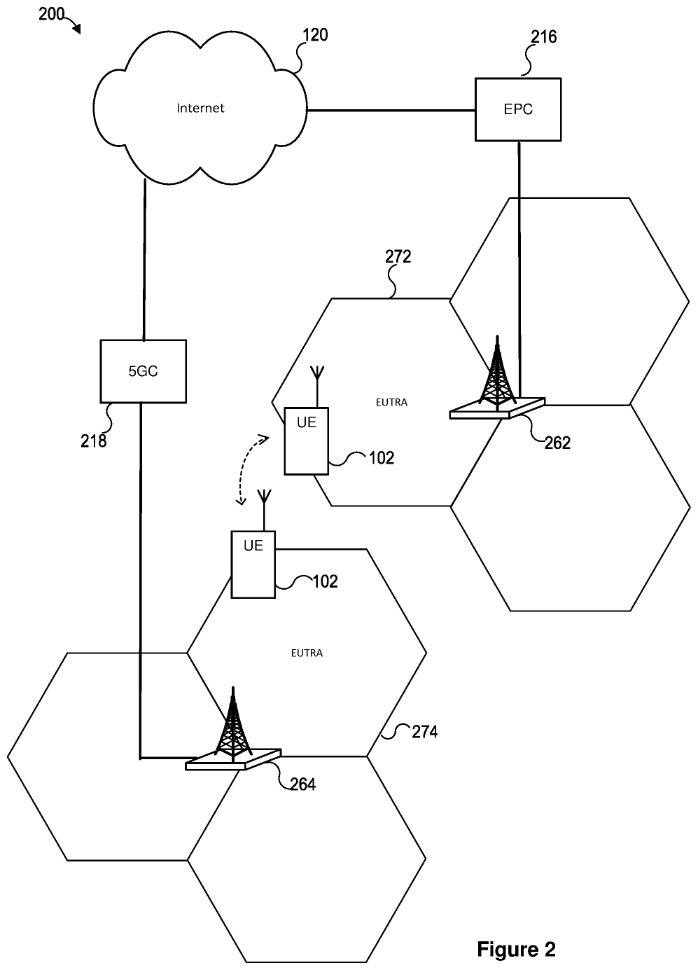

In operation, the RRC controller 142 generates outbound messages and processes inbound messages at an RRC sublayer of a protocol stack 150 of the air interface between the UE 112 and the base station 114. The protocol stack 150, illustrated in a simplified manner in FIG. 1, includes a physical layer 152 (commonly abbreviated as PHY), a medium access control (MAC) layer 154, a radio link control (RLC) layer 156, a packet data convergence protocol (PDCP) sublayer 158, and the RRC sublayer 160 as part of the access stratum 162. These layers are ordered as illustrated in FIG. 1. The non-access stratum 170 of the protocol stack 150 includes, among other sub-layers, an MM sublayer 172 for exchanging messages related to registration/attachment and location updates, for example. The MM sublayer can correspond to an Evolved MM (EMM) sublayer for evolved packet system (EPS) non-access-stratum (NAS) procedures and a 5G MM (SGMM) sublayer for 5th generation system (5GS) NAS procedures. As further illustrated in FIG. 2, the protocol stack 150 also can support higher-layer protocols 180 for various services and applications.

The RRC controller 142 can receive messages, commands, and updates from modules corresponding to the upper layers of the protocol stack 150 and similarly provide messages, commands, and updates to the lower layers of the protocol stack 150. For example, the RRC controller 142 can receive an indication of which CN type the upper layer MM controller 144 has chosen. The RRC controller 142 can then implement an RRC state machine that includes the RRC_IDLE and RRC_CONNECTED states of the chosen CN type and specify actions to be executed upon state transitions.

FIG. 2 illustrates another communication network 200, or another portion of the communication network 100, in which EUTRA base stations 262 and 264 are connected to EPC 216 and 5GC 218, respectively. The base station 262 covers a cell 272 and the base station 264 covers a cell 274. The UE 112 in various scenarios discussed below moves between the cell 272 or 274 and accordingly selects between the cells 272 and 274 based on various cell selection criteria. As mentioned previously, “select” as applied to a cell can refer to selecting a cell in the first instance or reselecting a cell according to cell reselection criteria. The base station 262 operates as eNB and the base station 264 operates as a next-generation eNB, or ng-eNB.

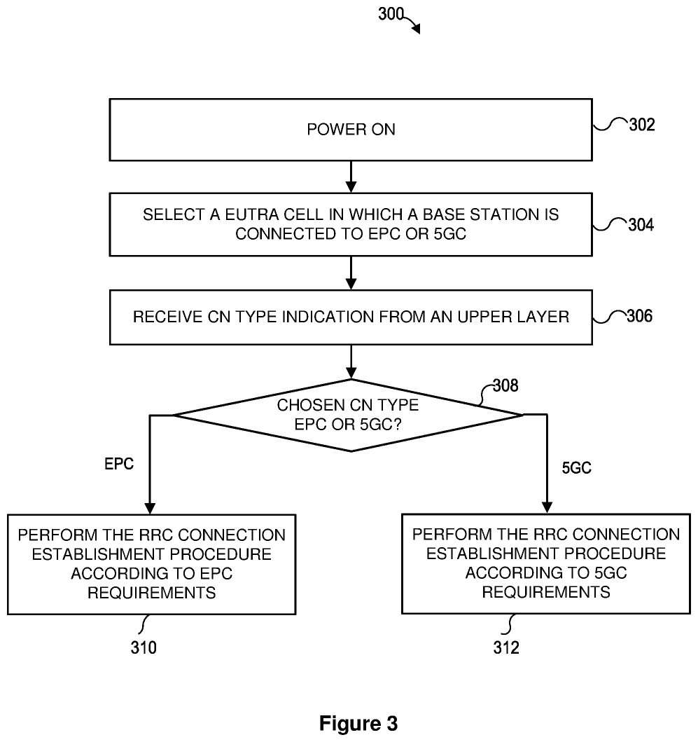

Next, several example methods which the UE 112 can implement and execute when the operating in the network 100 or 200 are discussed next with reference to FIGS. 3-6. The RRC controller 142 can implement at least some of the acts of these methods in software, firmware, hardware, or any suitable combination of software, firmware, and hardware. Although FIGS. 3-6 are discussed below with reference to the UE 112, in general any suitable user device can implement these methods.

Referring to FIG. 3, an example method 300 for connecting to a core network such as an EPC or a 5GC begins at block 302, when the UE 112 powers up and has not yet attached to the EPC or registered with the 5GC. In this disclosure, both the process of attaching to an EPC (which involves the EPS NAS Attach procedure specified in the 3GPP 24.301 v15.3.0 document, for example) and the process of registering with a 5GC (which involves the 5GS NAS Registration procedure specified in the 3GPP 24.501 v15.0.0 document, for example) can be understood as connecting to the corresponding core network. This connecting process may also be expanded to include future wireless core networks.

At block 304, the UE 112 selects a EUTRA cell in which the base station is connected to a core network such as an EPC or a 5GC. The EUTRA cell can belong to a PLMN. For example, referring back to FIG. 1, the UE 112 can select the cell 130. As discussed above, the UE 112 supports EUTRA via which the UE 112 can connect to an EPC or a 5GC. The MM controller 144 or another suitable entity in the UE 112 can determine whether the UE 112 should carry out the EPS NAS Attach procedure to connect to the EPC 16 or the 5GS NAS Registration procedure to connect to the 5GC 18. The MM controller 144 accordingly can choose EPC as the CN type and provide an appropriate indication to the RRC controller 142. More particularly, the MM controller 144 can choose a PLMN and provide a PLMN indication that indicates a PLMN identity of the PLMN to the RRC controller 142. Then, the RRC controller 142 can select the EUTRA cell that belongs to the chosen PLMN.

After the RRC controller 142 receives the indication of the chosen CN type from an upper layer at block 306, the RRC controller 142 determines, at block 308, whether the chosen CN type is EPC or 5GC. When the chosen CN type is EPC, the flow proceeds to block 310; otherwise, when the chosen CN type is 5GC, the flow proceeds to block 312.

At block 310, the RRC controller 142 performs the RRC connection establishment procedure according to EPC requirements. For example, the RRC controller 142 can carry out the access barring check as specified in section 5.3.3.2 of the R2-18113139 document and section 5.3.3.11 of the 3GPP TS 36.331 v15.2.2 document (referred to below simply as “TS 36.331”). On the other hand, at block 312, the RRC controller 142 performs the RRC connection establishment procedure according to 5GC requirements. For example, the RRC controller 142 can carry out the unified control procedure as specified in section 5.3.16.2 of R2-18113139. After the RRC connection establishment procedure completes at block 310 or 312, the MM controller 144 can carry out the EPS NAS Attach procedure or the 5GS NAS Registration procedure, as appropriate, using the established RRC connection.

According to the method 300, the RRC controller 142 does not rely on the determination of the CN type to which the UE 112 currently is connected to determine whether to execute block 310 or block 312, as the UE 112 does not yet have a connection to a CN.

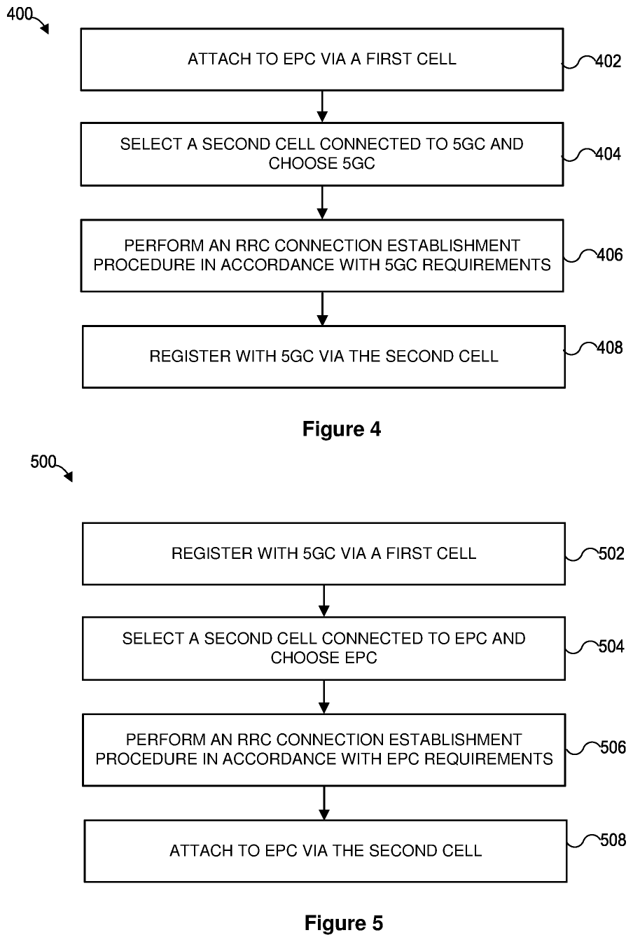

FIG. 4 illustrates an example method 400 for attaching to an EPC via one cell and subsequently registering with a 5GC via another cell. At block 402, the UE 112 attaches to an EPC via a first cell by successfully carrying out the EPS NAS Attach procedure. For example, referring back to FIG. 2, the UE 112 can attach to the EPC 16 via the EUTRA cell 272. After attaching to the EPC 16, the UE 112 camps on the EUTRA cell 272 and remains in the RRC_IDLE state.

At block 404, the UE 112 selects a different cell connected to a 5GC. Again referring back to FIG. 2, the UE 112 can gradually leave coverage of the EUTRA cell 272 and approach the coverage of the EUTRA cell 274. While in the RRC_IDLE state, the UE 112 can determine that the EUTRA cell 274 is preferable to the EUTRA cell 272 based on one or more cell selection/reselection criteria, and accordingly selects (or more specifically, reselects, in this instance) the EUTRA cell 274.

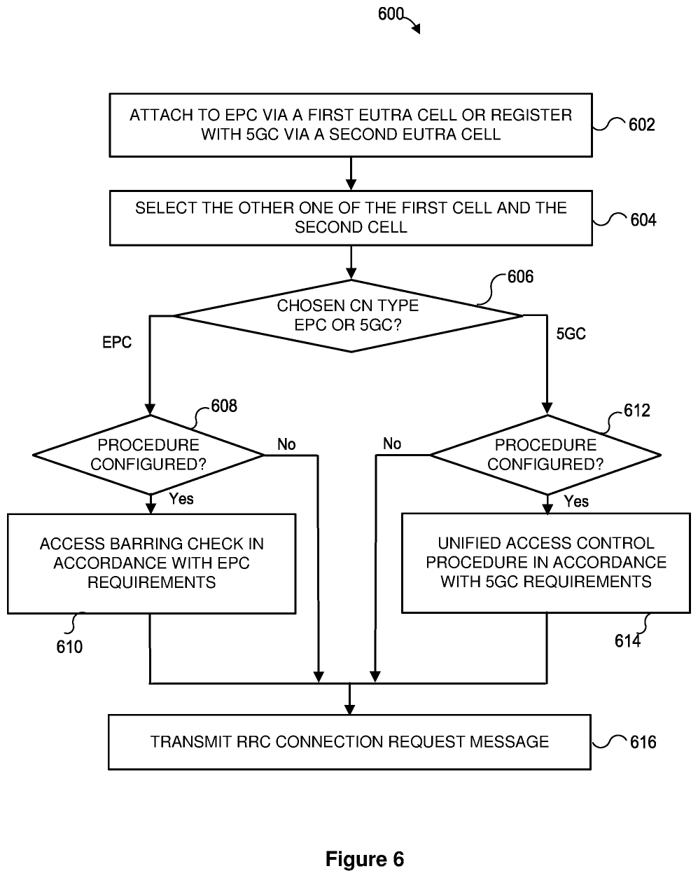

The UE 112 thus also chooses the 5GC 18 to which the base station 264 of the cell 274 is connected. The MM controller 144 of the UE 112 can determine that it should perform the 5GS NAS Registration procedure. To allow the UE 112 to transmit the relevant messages at the 5GMM sublayer, the UE 112 at block 406 performs the RRC establishment procedure in accordance with the relevant 5GC requirements, as discussed in more detail with reference to FIG. 6.

After completing the RRC establishment procedure, the UE 112 a block 408 registers with the 5GC via the second cell. In the example above, the UE 112 registers with the 5GC 18 via the cell 274. To this end, the UE 112 transmits the 5GS NAS Registration Request message of the 5GS NAS Registration procedure.

It is noted that performing the RRC establishment procedure in accordance with the requirements of the EPC, to which the UE 112 is connected at block 406, rather than the requirements of the chosen CN type 5GC, would cause the UE 112 to incorrectly perform certain steps of the RRC establishment procedure. Examples of such wrong steps are discussed below.

An example method 500 of FIG. 5 for registering with a 5GC also can be discussed in connection with reference to the example network of FIG. 2. Here, the UE 112 first attaches to a 5GC via a first cell by successfully carrying out the 5GS Registration procedure (block 502). For example, referring back to FIG. 2, the UE 112 can attach to the 5GC 18 via the EUTRA cell 274. After attaching to the 5GC 18, the UE 112 camps on the EUTRA cell 274 and remains in the RRC_IDLE state.

At block 504, the UE 112 selects a different cell connected to an EPC. Again referring back to FIG. 2, the UE 112 can gradually leave coverage of the EUTRA cell 274 and approach the coverage of the EUTRA cell 272. While in the RRC_IDLE state, the UE 112 can determine that the EUTRA cell 272 is preferable to the EUTRA cell 274 based on one or more cell selection/reselection criteria, and accordingly selects/reselects the EUTRA cell 272.

The UE 112 chooses the EPC 16 to which the base station 262 of the cell 272 is connected. The MM controller 144 of the UE 112 accordingly can determine that it should perform an EPS NAS Tracking Area Update procedure. To this end, the UE 112 at block 506 performs the RRC establishment procedure in accordance with the relevant EPC requirements.

After completing the RRC establishment procedure, the UE 112 at block 508 performs the 5GS NAS Registration procedure via the second cell, which is the cell 272 in the example of FIG. 2. More specifically, the UE 112 initiates the 5GS NAS Registration procedure by transmitting the 5GS NAS Registration Request message.

To illustrate some of the differences in the RRC establishment procedure performed according to EPC or 5GC requirements, FIG. 6 illustrates an example method 600 for carrying out an access check procedure upon selecting a cell connected to a CN of a different CN type than the previous cell of the user device. The method 600 begins at block 602, where the UE 112 attaches to or registers with one of two EUTRA cells: the first cell connected to an EPC or a second cell connected to a 5GC. The UE 112 then selects the other cell at block 604. Referring back to FIG. 4, blocks 602 and 604 can correspond to blocks 402 and 404, respectively; or, referring back to FIG. 5, blocks 602 and 604 can correspond to blocks 502 and 504, respectively. Next, at block 606, the UE 112 checks whether the chosen CN type is EPC or 5GC. The flow proceeds to block 608 when the CN type is EPC or to block 612 when the CN type if 5GC.

At block 608, the UE 112 checks whether the base station of the EUTRA cell has supplied access barring configuration in a System Information Block Type 2 (SystemInformationBlockType2) information element. When the base station of the EUTRA cell has not supplied access barring configuration in a System Information Block Type 2 information element, or when the access barring configuration does not include a sub barring configuration (e.g., ac-B arringForEmergency, ac-BarringForMO-Signalling, or ac-BarringForMO-Data) for an establishment cause, the UE 112 does not perform the access barring check and the flow proceeds directly to block 616. Otherwise, the flow proceeds to block 610.

When access barring configuration is included, the UE 112 performs the access barring check at block 610 according to the access barring configuration and specifies an establishment cause, which indicates why the UE 112 performs the RRC connection establishment procedure, according to sections 5.3.3.2 and 5.3.3.11 of TS 36.331. More particularly, the access barring configuration includes at least one of elements ac-BarringInfo, acdc-BarringForCommon-r13 and acdc-BarringPerPLMN-List-r13 as defined in the TS 36.331 document. The ac-Barringlnfo includes at least one of elements ac-BarringFor Emergency, ac-BarringForMO-Signalling and ac-BarringForMO-Data. These elements specify different types of barring: emergency calls, mobile-originated calls, mobile-originated data, etc. When UE 112 determines that the EUTRA cell is not barred according to the access barring check, the UE transmits the RRC Connection Request message at block 616 according to section 5.3.3.3 of TS 36.331. Otherwise, the UE 112 does not transmit the RRC Connection Request message, and the method 600 completes.

At block 612, the UE 112 checks whether the base station of the EUTRA cell has supplied a System Information Block Type XX (SystemInformationBlockTypeXX) information element. When the System Information Block Type XX does not specify access configuration for the relevant access category, of when the base station has not broadcast System Information Block Type XX at all, the flow proceeds directly to block 616. Otherwise, the flow proceeds to block 614.

At block 614, the UE 112 performs a unified access control (UAC) procedure according to the information in the System Information Block Type XX, formatted according to R2-1813139. This specification provides, for example, such values of “XX” as 23, 24, 25, 26, or 27, defining certain block types. When the UE 112 determines that the EUTRA cell is not barred for an access category according to the UAC procedure, the flow proceeds to block 616. Otherwise, the UE 112 does not transmit the RRC Connection Request message, and the method 600 completes.

Upon carrying out an access check procedure according to the chosen CN type, the flow proceeds to block 616, where the UE 112 transmits an RRC connection request message. The UE 112 can format the RRC Connection Request message according to section 5.3.3.3 of TS 36.331, regardless of the chosen CN type.

On the other hand, when a UE performs an access check procedure according to the CN type of the core network to which the UE currently is connected (instead of doing so according to the chosen CN type), the UE performs access barring check per section 5.3.3.11 of TS 36.331 when reselecting a cell connected to a 5GC after being connected to an EPC via another cell. The UE does not perform a UAC procedure specified in section 5.3.16.2 of the R2-1813139document. As a result, the next-generation evolved Node B (ng-eNB) of the reselected cell cannot control the UE using the UAC mechanism when the reselected cell or the 5GC is congested.

As another example, when a UE selects a cell connected to an EPC after being connected to a 5GC via another cell, and the UE performs an access check procedure according to 5GC requirements (instead of doing so for the chosen CN type of EPC), the UE performs a UAC procedure specified in section 5.3.16.2 of the R2-1813139document and does not perform an access barring check per section 5.3.3.11 of TS 36.331. As a result, the eNB of the reselected cell cannot control the UE using the access barring check mechanism when the reselected cell or the EPC is congested.

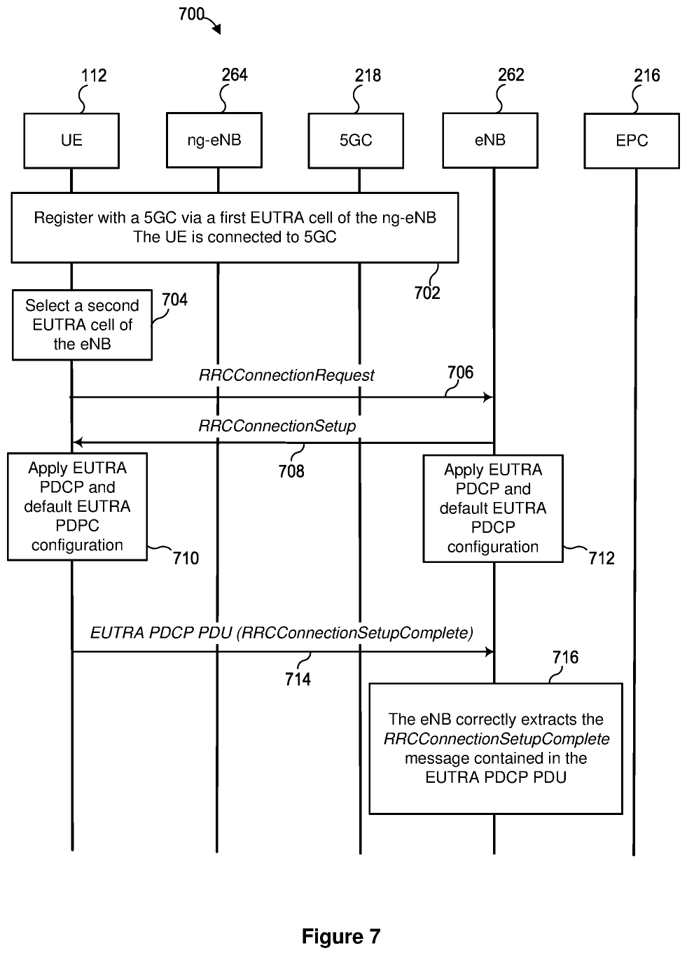

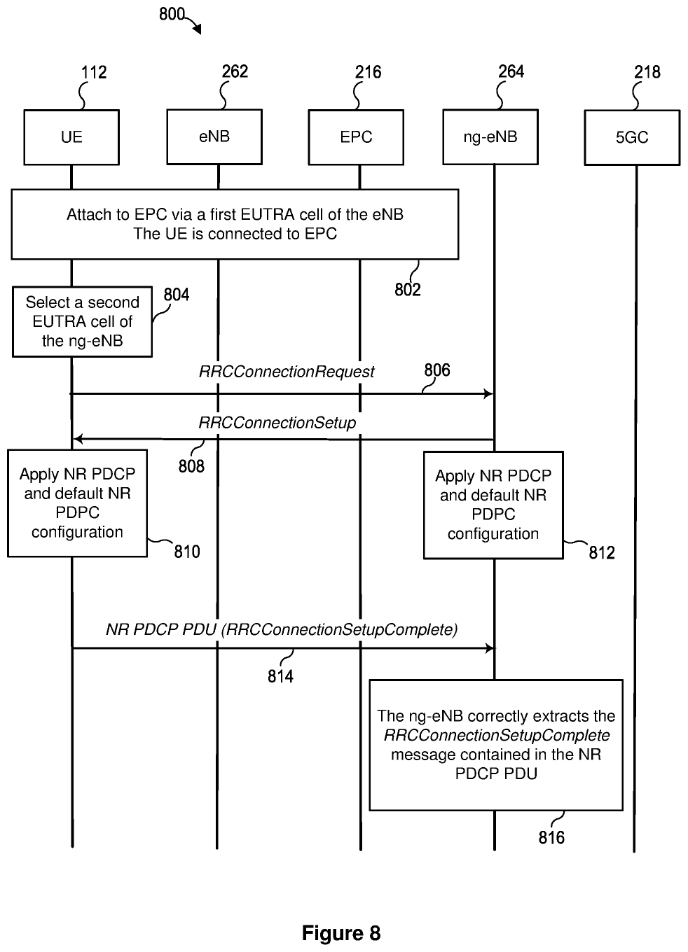

Next, application of a proper PDCP when the UE 112 connects to a CN of a different CN type is discussed with reference to the messaging diagrams of FIGS. 7 and 8.

Referring first to a diagram 700 of FIG. 7, the UE 112 registers 702 with the 5GC 18 via the EUTRA cell 274 of the ng-eNB 264. As discussed above, the UE 112 can do so by performing a 5GS NAS Registration procedure. Similar to the scenarios discussed above, the UE 112 then selects 704 the EUTRA cell 272 of the eNB 262. The UE 112 accordingly chooses EPC as the CN type. The UE 112 sends 706 an RRC Connection Request message to the eNB 262, and the eNB responds 708 with an RRC Connection Setup message.

Both the UE 112 and the eNB 262 apply their respective EUTRA PDCP setups and default EUTRA PDCP configurations (710, 712). The UE 112 in this example scenario sets up a signaling radio bearer 1 (SRB1) in accordance with the received RRC Connection Setup message. Because the chosen CN type is EPC, the UE 112 uses EUTRA PDCP for all subsequent RRC messages transmitted and received via the SRB1. Further, because the chosen CN type is EPC, the UE 112 applies the default EUTRA PDPC configuration when using the SRB1. Then, the UE indicates an RRC Connection Setup Complete message over an EUTRA PDCP Protocol Data Unit (PDU) (714). The eNB 262 correctly extracts 716 the RRC Connection Setup Complete message because the PDCP configurations at the UE and the eNB are both EUTRA.

Now referring to a diagram 800 of FIG. 8, the UE 112 attaches 802 or provides a tracking area update to the EPC 16 via the EUTRA cell 272 of the eNB 262. In particular, the UE 112 performs an EPS NAS Attach procedure or an EPS Tracking Area Update procedure. Similar to the scenarios discussed above, the UE 112 then selects 804 the EUTRA cell 274 of the ng-eNB 264. The UE 112 accordingly chooses 5GC as the CN type. The UE 112 sends 806 an RRC Connection Request message to the ng-eNB 264 (806), and the ng-eNB responds 808 with an RRC Connection Setup message.

Both the UE 12 and the ng-eNB 63 apply 810,812 their respective NR PDCP setups and default NR PDCP configurations. The UE 112 sets up an SRB1 in accordance with the RRC Connection Setup message. Because the chosen CN type is 5GC, the UE 112 uses new radio (NR) PDCP for all subsequent RRC messages transmitted and received via the SRB1 (810), to correspond to the configuration at the ng-eNB 264 (812, 816). Further, because the chosen CN type is 5GC, the UE 112 applies the default NR PDPC configuration when using the SRB1. Then, the UE indicates 814 an RRC Connection Setup Complete message over an NR PDCP PDU. The ng-eNB 264 correctly extracts 816 the RRC Connection Setup Complete message because the PDCP configurations at the UE and the eNB are both NR.

In contrast to the scenarios of FIGS. 7 and 8, when a UE determines PDCP based on the CN type of the core network to which the UE currently is connected (e.g., at 702, 802), communication problems may occur between the UE and the eNB or ng-eNB after selecting (e.g., 704, 804) to a second EUTRA cell. For example, when the UE is connected to a 5GC and selects (or, more specifically, reselects) a cell connected to an EPC, and the UE sets up an SRB1 according to 5GC requirements, the UE applies the default NR PDCP configuration and uses NR PDCP for all subsequent RRC messages transmitted and received by the UE. However, because the eNB does not support NR PDCP, the eNB uses EUTRA PDCP, and the UE and the eNB fail to communicate.

As another example, when the UE is connected to an EPC and selects a cell connected to a 5GC, and the UE sets up an SRB1 according to EPC requirements, the UE applies the default EUTRA PDCP configuration and uses EUTRA PDCP for all subsequent RRC messages transmitted and received by the UE. However, because ng-eNB uses NR PDCP, the UE and the ng-eNB fail to communicate.

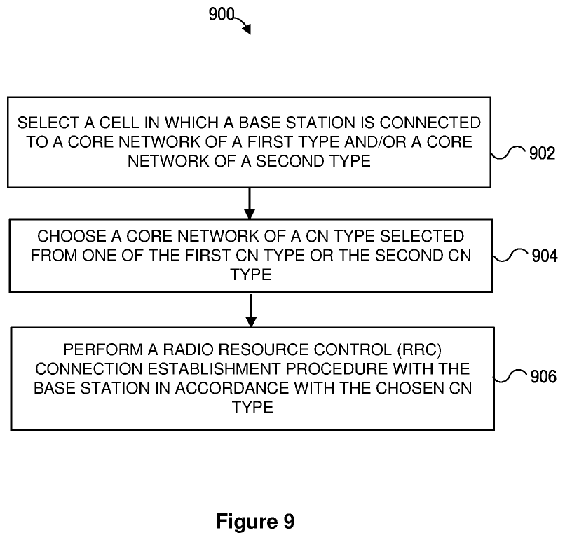

For further clarity, FIG. 9 illustrates an example method 900 which a UE of this disclosure can implement to connect properly to core networks of different types. The method 900 can be implemented in hardware, software, firmware, or any suitable combination of hardware, software, and firmware.

The UE that implements the method 900 supports an air interface for connecting to core networks of different types. For example, the UE can support EUTRA via which the UE can access core networks of types EPC and 5GC.

The method 900 begins at block 902, where the UE selects (or reselects) a cell. The UE can select the cell based on any available cell selection or reselection criteria. The base station of the cell is connected to a core network of one of the types which the air interface of the UE supports. For example, as illustrated in FIGS. 1 and 2, a base station can be connected to an EPC or a 5GC, and the UE can support EUTRA.

According to some embodiments, the UE selects the cell at block 902 when the UE is not yet connected to any CNs. For example, referring back to blocks 302 and 304 in FIG. 3, the UE can power up and select a cell in which the base station is connected to EPC or 5GC. According to other embodiments, the UE selects (or, more specifically, reselects) the cell at block 902 after connecting to a CN of another type. For example, as illustrated in block 402 of FIG. 4, block 502 of FIG. 5, or block 602 of FIG. 6, the UE can attach to or register with a CN of type other than the CN type of the core network of the cell selected at block 404, block 504, or block 604, respectively. More generally, the UE at block 902 can select a cell with a base station connected to a core network of any type which the air interface of the UE and the base station supports.

At block 904, the UE chooses the CN of a CN type supported by the air interface of the UE. Referring back to FIGS. 1-6, the UE 112 in these examples supports EUTRA, which allows UEs connect to core networks of type EPC or 5GC, and accordingly the UE 112 chooses the CN from among EPC and 5GC. More generally, the UE can choose from among any number of CNs which the air interface supports. The UE's choice may be guided by higher layer messages from, for example, the UE's MM controller 144.

Next, at block 906, the UE's RRC controller 142 performs the RRC connection establishment procedure according to the chosen CN type. Referring back to FIG. 3, for example, the UE can check the chosen CN type at block 308 and perform the procedure according to the corresponding requirements. As illustrated in FIGS. 3-5, a UE that supports EUTRA can perform the RRC connection establishment procedure according to either EPC or 5GC requirements.

Performing the RRC connection establishment procedure according to a particular set of requirements can include determining which access check procedure should be performed, as illustrated in FIG. 6 as well as determining which PDCP configuration should apply, as illustrated in FIGS. 7 and 8. More generally, at block 906 the UE can use the chosen CN type to determine how outbound messages should be formatted, how inbound messages should be processed, which information to include in the outbound messages and expect in inbound messages, which conditions to check, which restrictions to apply, etc.

Although the techniques of this disclosure are developed for the scenarios where a UE connects to a CN of a different CN type than the previous CN of the UE, these techniques also provide proper connections when the UE connects to the CN of the same CN type as the one used before. For example, if the UE previously was connected to a 5GC, and at block 902 the UE selects a cell in which the base station also is connected to a same or different 5GC, the UE will perform the proper RRC connection establishment procedure in accordance with the methods and scenarios of FIGS. 3-9.

The following additional considerations apply to the foregoing discussion.

A user device in which the techniques of this disclosure can be implemented (e.g., the UE 112) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional alternative structural and functional designs for performing RRC connection establishment procedure through the disclosed principles herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

What is claimed is:

1. A method in a user device that supports an air interface for connecting to core networks of different types, the method comprising:
selecting, by processing hardware, a cell in which a base station is connected to one of a core network (CN) of a first CN type or a CN of a second CN type;
choosing, by the processing hardware, a CN type from one of the first CN type or the second CN type; and
performing, by the processing hardware, a radio resource control (RRC) connection establishment procedure with the base station in accordance with the chosen CN type.

2. The method of claim 1, wherein selecting the cell includes selecting the cell when the user device is connected to neither the CN of the first CN type nor the CN of the second CN type.

3. The method of claim 1, wherein the selected cell is a second cell connected to the CN of the second CN type, the method further comprising:
prior to selecting the second cell, connecting, by the processing hardware, to the CN of the first CN type via a first cell.

4. The method of claim 3, wherein performing the RRC connection establishment procedure in accordance with the chosen CN type includes performing, by the processing hardware, an access check procedure in accordance with the chosen CN type.

5. The method of claim 3, wherein performing the RRC connection establishment procedure in accordance with the chosen CN type includes:
processing, by the processing hardware, system information block data received from the base station, in accordance with the chosen CN type; and
in response to determining that the base station does not specify access configuration, not performing an access check procedure.

6. The method of claim 3, wherein performing the RRC connection establishment procedure in accordance with the chosen CN type includes choosing, by the processing hardware, a packet data convergence protocol (PDCP) in accordance with the chosen CN type.

7. The method of claim 1, wherein choosing the CN type includes receiving an indication from an upper layer of a communication protocol stack.

8. The method of claim 7, wherein the indication of the CN type from the upper layer includes receiving the indication from a mobility management (MM) entity.

9. The method of claim 1, further comprising:
connecting, by the processing hardware, to the CN of the chosen CN type via a connection established by performing the RRC connection establishment procedure.

10. The method of claim 1, wherein performing the RRC connection establishment procedure in accordance with the chosen CN type includes formatting at least one outbound message associated with the RRC connection establishment procedure in accordance with the chosen CN type.

11. A non-transitory medium storing thereon instructions that, when executed by processing hardware of a user device, cause the user device to:
select a cell in which a base station is connected to at least one of a core network (CN) of a first CN type or a core network of a second CN type;
choose one of the first CN type or the second CN type; and
perform a radio resource control (RRC) connection establishment procedure with the base station in accordance with the chosen CN type, via an air interface for connecting to core networks of at least the first CN type and the chosen CN type.

12. The non-transitory medium 11, wherein to select the cell, the instructions cause the user device to select the cell when the user device is connected to neither the CN of the first CN type nor the CN of the second CN type.

13. The non-transitory medium 11, wherein the selected cell is a second cell connected to the CN of the second CN type, and wherein the instructions cause the user device to:
prior to selecting the second cell, connect to the CN of the first CN type via a first cell.

14. The non-transitory medium 13, wherein to perform the RRC connection establishment procedure in accordance with the chosen CN type, the instructions cause the user device to perform an access check procedure in accordance with the chosen CN type.

15. The non-transitory medium 13, wherein to perform the RRC connection establishment procedure in accordance with the chosen CN type, the instructions cause the user device to:
process system information block data received from the base station, in accordance with the chosen CN type; and
in response to determining that the base station does not specify access configuration, not perform an access check procedure.

16. The non-transitory medium 13, wherein to perform the RRC connection establishment procedure in accordance with the chosen CN type, the instructions cause the user device to choose a packet data convergence protocol (PDCP) in accordance with the chosen CN type.

17. The non-transitory medium 11, wherein to choose the CN type, the instructions cause the user device to receive an indication from an upper layer of a communication protocol stack.

18. The non-transitory medium 17, wherein the indication of the CN type is received from a mobility management (MM) entity.

19. The non-transitory medium 11, wherein the instructions further cause the user device to connect to the CN of the chosen CN type via a connection established by performing the RRC connection establishment procedure.

20. The non-transitory medium of claim 11, wherein to perform the RRC connection establishment procedure in accordance with the chosen CN type, the instructions cause the user device to format at least one outbound message associated with the RRC connection establishment procedure in accordance with the chosen CN type.
